(19) United States
(12) Patent Application Publication
(10) Pub. No.: US 2005/0252861 A1
(43) Pub. Date: Nov. 17, 2005

(54) Apparatus and method for oil spill recovery

(76) Inventor: Chitsan Lin, Kaohsiung (TW)

Correspondence Address: TROXELL LAW OFFICE PLLC, 5205 LEESBURG PIKE, SUITE 1404, FALLS CHURCH, VA, 22041, US

(21) Appl. No.: 10/845,187

(22) Filed: May 14, 2004

(51) Int. Cl. C02F 1/28

(52) U.S. Cl. 210/671; 210/691; 210/242.4; 210/924

(57) ABSTRACT

A spilled oil recovery method and its apparatus are described. The apparatus has adsorbent materials and an adsorbent container. The adsorbent materials having hydrophobic characteristic come from recycled synthetic rubber and fibers as oil adsorbents. The apparatus can be reused more than 100 times, due to the elastic properly of the adsorbent materials. The adsorbed oil is recovered by mechanical compression.

### FIELD OF THE INVENTION

The present invention relates to a method for contamination treatment and more particularly, to the adsorption and recovery) of spilled oil.

### BACKGROUND OF THE INVENTION

Oil spills in the environment not only cause property loss, but also have a strong negative impact upon the entire ecosystem. According to the UNEP report in 1991, the amount of oil spilled has decreased since 1976. Nevertheless, crude oil and petroleum products that have found their way into the marine environment to about 10,000 to 100,000 tons annually in the past decade.

Many ways have been provided to deal with this problem.

Fuel oil or crude oil is mostly recovered by aspirating the layer of oil floating on the water surface using a suction apparatus, and materials have been provided such as chemical agent and adsorbent. However, the performance of the apparatus is restricted by the weather condition or marine facies, and the suction apparatus is not available due to the high viscosity of crude oil. Furthermore chemical agents applied to disperse and biodegrade oil spills are far from beneficial, and may result in even worse environmental damage.

Several types of adsorbent such as organic products, mineral compounds, and synthetic products have been provided. U.S. Pat. No. 5,352,780, U.S. Pat. No. 5,114,593 U.S. Pat. No. 4,969,774, U.S. Pat. No. 4,959,154, U.S. Pat. No. 3,902,998, U.S. Pat. No. 3,617,564 disclose the utilization of cellulose flakes, pulverized aquatic lily plant, puffed cereals, wood chips, rice hulls, and corncob respectively for the removal of oil spills from water and land. However the adsorbents are not reusable. Mineral compounds have been used. U.S. Pat. No. 6,030,536 discloses utilization of titanium dioxide particles to dispose of spilled oil. Similarly, the adsorbed oil cannot be recovered. A method of recovering spilled oil has been provided with polymer materials. U.S. Pat. No. 5,885,451 discloses the provision of fibril material coated or impregnated with an oleophylic, hydrophobic composition. The apparatus can be reused to recover spilled oil; however, after recovery the apparatus must be processed to re-impregnate the materials with the oleophylic, hydrophobic composition.

### SUMMARY OF THE INVENTION

A spilled oil recovery method and an apparatus for the same are provided. The apparatus consists of adsorbent materials and a container. The adsorbent materials having hydrophobic characteristic as oil adsorbents come from recycled synthetic rubber and fibers. The apparatus can be reused more than 100 times, due to the elastic property of the adsorbent materials. The adsorbent container may comprise sidewalls with openings allowing liquid pass through. The shape and size of container may vary by design and application. The adsorbed oil is recovered by mechanical compression. The apparatus can be used by itself or be combined with others with wires, films, and threads in application.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is the results of the reusability test indicating that the reusable apparatus can be reused more than 100 times without losing its adsorption capacity.

### DETAILED DESCRIPTION OF THE PREFERRED EMBODIMENT

Although ways to dispose of spilled oil floating on or suspended in water or spilled oil sludge on the land have been provided, no method yet exists that also can treat and recover said spilled oil in a cost-competitive manner. A cheaper method and an apparatus to deal with those problems are provided according to an embodiment of present invention.

The apparatus consists of an adsorbent and an adsorbent container. The shape and size of the apparatus may vary by design and application; in the preferred embodiment it is shaped like a disk. The dimension of the apparatus may be as small as a coin. In the preferred embodiment, the size of the container is 5.5 cm in diameter, and in another preferred embodiment it may be used to cover several square meter of water area.

The adsorbent consists essentially of materials having elastic and hydrophobic characteristics. Because of the hydrophobic property of the adsorbent, it retains oil and excludes water. The adsorbent materials comprise synthetic rubber, for example. In the preferred embodiment the synthetic rubber comprises recycled tires cut or milled into powder. The adsorption capacity may be increased as well as the diameter decreasing because of the increase of the surface area of the adsorbent. However, the adsorbent with a smaller diameter leaks from the adsorbent container. The diameter of the recycled tire powder is thus about 1 to 80 mesh. Furthermore, when compared with the prior arts made of nature material the density of the adsorbent is greater than water, and is very stable for storage.

Adsorbing tests may be conducted according to American Society for Testing and Material F726-99 Standard Test Method for Sorbent Performance of Adsorbents. In an embodiment using recycled tire powder of 40 mesh as adsorbent, 2.84 gram spilled oil is adsorbed, on average. The adsorbent materials may be used in conjunction with hydrophobic fibril materials preferably of polypropylene fiber, preferably in a ratio of 1:1, and more preferably of 1:10. In the more preferable embodiment the adsorption may be 7.78 grams in average per gram adsorbent. Because of the elastic property of the adsorbent, the spilled oil is recovered by mechanical compression, and the apparatus may be reused at least 100 times. In other words, each gram adsorbent can adsorb at least 778 grams of spilled oil. Since the synthetic rubber may preferably come from recycled tires in which the cost per ton is less than $100, the cost of adsorbing spilled oil is less than $0.35 per ton. In some embodiments, the cost of the adsorbent comprising polypropylene fiber could be less than $210 and cost of adsorbing spilled oil less than $0.27 per ton. The present invention is thus very competitive when compared with the commercial product Ecosol. Table I is the comparison of the various adsorbent materials.

TABLE I
The comparison of various adsorbent materials

| | | Recycled-tire | |
|---|---|---|---|
| | | powder associated | Ecosol |
| | Recycled-tire | with | (commercial |
| | powder | polypropylene | product) |
| Density | >water | >water | <water |
| Adsorption amount of | 2.84 (×100) | 7.78 (×100) | 103.3 |
| spilled oil (gram) | | | |
| (spilled oil/adsorbent) | | | |
| Reusability | >100 | >100 | 1 |
| Price of adsorbent | <$100 | <$200 | $64,000 |
| (ton) | | | |
| The cost of adsorption | <$0.35 | <$0.25 | $620 |
| (per ton spilled oil) | | | |

The adsorbent container with the adsorbent retained therein may comprise sidewalls with openings allowing liquid pass through. The materials of adsorbent container having a density greater or less than water may vary by design and application. In the preferred embodiment, the adsorbent container made of non-woven material.

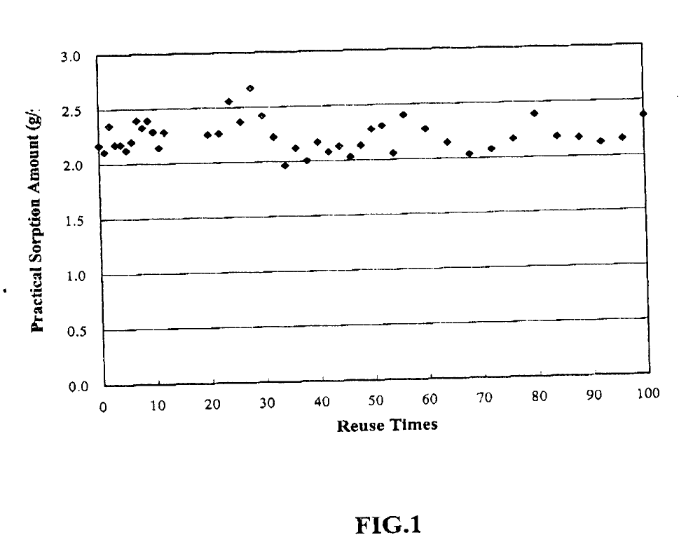

A method is provided to adsorb spilled oil floating on or suspended in water or spilled oil sludge on land, in which the apparatus is brought into contact with said spilled oil, and the oil is recovered by compression. The steps of bringing the apparatus into contact with spilled oil may be conducted by covering, surrounding, immersing, and passing the apparatus through the spilled oil. In an embodiment the apparatus is immersed in water via its characteristic of having a density greater than that of water. The apparatus can be used in a temperature range of seawater from −4° C. to 50° C. without its adsorption ability decreasing to below 40%. In some embodiments, the adsorption capacity in cool seawater may be greater than that in warm. The performance of the apparatus is thus not affected by weather such as, for example, wind, waves, and water temperature. The apparatus can be used by itself or be combined others with wires, films, and threads in application. In some embodiments the apparatus is used as a unit of an adsorbent strip. The recovering of spilled oil may be performed by mechanical procedures of compressing the oil out of the adsorbent apparatus. In the preferred embodiment, a compressing machine is used to compress the adsorbent strips for recovering spilled oil. The adsorbent apparatus may be reused. In the preferred embodiment, the apparatus may be reused at least 100 times. FIG. 1 is the results of the reusability test indicating that the reused apparatus can be reused more than 100 times without losing its adsorption capacity.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A method for adsorbing spilled oil floating on or suspended in water, comprising the steps of:
providing an apparatus comprising an adsorbent made of recycled hydrophobic materials having elastic property with a density greater than water, and a container;
sinking the apparatus into the water from the surface of the water to contact with said spilled oil; and
recovering the oil adsorbed by mechanical compression.

2. The method according to claim 1, wherein the step of bringing the apparatus into contact with said spilled oil comprises covering, surrounding, immersing, or passing the apparatus through the spilled oil.

3. The method according to claim 1, wherein the hydrophobic materials having elastic property comprise synthetic rubber.

4. The method according to claim 3, wherein the recycled synthetic rubber comprises recycled tires milled or cut into powder.

5. The method according to claim 4, wherein a dimension of tire powder is about 1 to 80 mesh.

6. The method according to claim 1, furthermore comprising another recycled hydrophobic materials with fibril structure.

7. The method according to claim 6, wherein the hydrophobic materials with fibrous structure comprise polypropylene and polyethylene.

8. The method according to claim 1, wherein a spilled oil recovery process is performed by mechanical procedures compressing the oil out of the adsorbent materials.

9. The method according to claim 8, wherein the adsorbent materials can be reused at least 100 times by repeating the spilled oil recovery process.

10. An apparatus for adsorbing spilled oil floating on or suspended in water, and spilled oil sludge on land, the apparatus comprising oil adsorbent materials made of recycled hydrophobic materials having elastic property with a density greater than water, and a container, wherein the oil adsorbent materials comprise recycled synthetic rubber.

11. (canceled)

12. The apparatus according to claim 10, furthermore comprising another recycled hydrophobic materials with fibril structure.

13. The apparatus according to claim 12, wherein the hydrophobic material comprises polypropylene.

14. The apparatus according to claim 10, wherein the container's sidewalls with openings allowing liquid pass through.

15. The apparatus according to claim 14, wherein the adsorbent materials are packed and kept in the container.

16. The apparatus according to claim 10, wherein a spilled oil recovery process is performed by mechanical procedures compressing the oil out of the recovering apparatus.

17. The apparatus according to claim 16, wherein the spilled oil recovering apparatus can be reused at least 100 times by repeating the spilled oil recovery process.

18. The apparatus according to claim 17, wherein the spilled oil recovering apparatus can be used individually or in combination with other apparatuses by wires, films, and threads in application.

19. A material for adsorbing spilled oil floating on or suspended in water, and spilled oil sludge on land, the material comprising:
oil adsorbent materials made of synthetic rubber of recycled tires milled or cut into powder; and
hydrophobic materials having a fibril structure.

20. The material according to claim 19, wherein the hydrophobic materials with fibrous structure comprise polypropylene and polyethylene.
